(19) United States
(12) Patent Application Publication
(10) Pub. No.: US 2017/0270735 A1
(43) Pub. Date: Sep. 21, 2017

(54) COIN HANDLING APPARATUS

(71) Applicant: GLORY LTD., Himeji-shi (JP)

(72) Inventors: Eiichi NOMURA, Hyogo (JP); Mitsuo TANAKA, Hyogo (JP); Noriyuki MURAMOTO, Hyogo (JP)

(73) Assignee: GLORY LTD., Himeji-shi (JP)

(21) Appl. No.: 15/071,397

(22) Filed: Mar. 16, 2016

(51) Int. Cl. G07D 3/06; G07D 3/14

(52) U.S. Cl. CPC G07D 3/06; G07D 3/14

(57) ABSTRACT

A coin handling apparatus includes: a recognition unit; an arcuate coin track; a driving unit configured to move coins along the coin track in a single layer and a single file; a plurality of active sorting units disposed in the coin track and configured to actively sort the coins based on recognition results; and at least one passive sorting unit disposed in the coin track and configured to passively sort the coins.

### BACKGROUND

U.S. Pat. No. 7,704,133 describes a desktop coin handling apparatus. This coin handling apparatus includes an arcuate coin track along which coins are moved, and a driving unit configured to move the coins along the coin track in a single layer and a single file. The coin handling apparatus has, in the coin track, a single offsort opening and six sorting openings. This coin handling apparatus is able to sort valid coins by six denominations and offsort invalid coins.

U.S. Pat. No. 8,267,755 describes a disk assembly which constitutes the driving unit of the coin handling apparatus and moves the coins. U.S. Pat. No. 9,070,240 describes control for offsorting the coins in the coin handling apparatus.

U.S. Pat. No. 8,443,959 describes a coin handling apparatus configured in a different manner from the above-described coin handling apparatus. This coin handling apparatus includes first and second eliminating units for eliminating abnormal coins.

### SUMMARY

The coin handling apparatuses described in those patent documents such as U.S. Pat. No. 7,704,133 have only a single offsort opening. For example, when both of forged coins and unfit coins are offsorted, the coin handling apparatus needs to perform a handling process again for sorting the offsorted coins into forged coins and unfit coins.

The present disclosure is advantageous because sorting of the coins according to authenticity and sorting of the coins according to fitness of the coins, for example, may be performed in a single handling process according to the present disclosure. Specifically, the coin handling apparatus disclosed herein includes: a recognition unit configured to recognize coins; an arcuate coin track configured to move the recognized coins; a driving unit configured to move the coins along the coin track in a single layer and a single file; a plurality of active sorting units disposed in the coin track and configured to actively sort the coins based on recognition results; and at least one passive sorting unit disposed in the coin track and configured to passively sort the coins.

The active sorting units actively sort the coins based on the recognition results of the recognition unit. The active sorting units are able to sort the coins according to their authenticity. Further, the active sorting units are able to sort the coins according to their fitness. The coin handling apparatus includes a plurality of active sorting units. The coin handling apparatus is able to perform, in a single handling process, the sorting of the coins according to their authenticity and the sorting of the coins according to their fitness.

The coin track may have an arcuate reference edge disposed along the coin track and configured to regulate an outer peripheral edge of each coin traveling along the coin track. Each of the active sorting units may include a diverter disposed along the arcuate reference edge and configured to be operable to project into the coin track in order to move the coins selected based on the recognition results in a direction away from the arcuate reference edge, an opening spaced by a rail portion so as to be located at a predetermined interval from the arcuate reference edge and configured to receive the coins moved by the diverter in the direction away from the arcuate reference edge, and a deflector disposed above the opening to leave a gap that allows the coins to pass through, positioned to contact with a tipped up edge of each of the coins, and configured to deflect the coins into the opening.

The diverter and the deflector of each of the active sorting units allow the selected coins to be introduced into the opening with reliability.

The passive sorting unit may be spaced by the rail portion so as to be located at a predetermined interval from the arcuate reference edge and may have an opening configured to receive the coins having a smaller diameter than a predetermined size.

The passive sorting unit is allowed to receive the coins having a diameter corresponding to the size of the opening.

The passive sorting unit may be disposed downstream of the plurality of active sorting units in a traveling direction of the coins.

The passive sorting unit is allowed to sort the coins that have passed through the active sorting units.

The active sorting units may sort the coins according to authenticity of the coins.

The active sorting units may sort the coins according to fitness of the coins.

The active sorting units may sort the coins according to whether the coins are new or old.

The active sorting units may sort the coins according to diameters of the coins.

The active sorting units may sort the coins according to denominations of the coins.

The active sorting units may receive only a predetermined number of coins of a selected denomination.

The active sorting units may sort the coins according to a predetermined rejection factor.

The active sorting units may sort the coins according to a predetermined overflow factor.

The active sorting units may receive the coins that are not received by the passive sorting unit.

The driving unit may include a plurality of elastic fins provided on a lower surface of a coin moving disk and configured to press each of the coins traveling along the coin track from above, the coin moving disk rotating about a shaft. A distance between a bottom of the elastic fins and a surface of the coin track on which the coins slide may be smaller than a thickness of the coins.

In this configuration, the driving unit is allowed to move the coins along the coin track with reliability.

The distance between the bottom of the elastic fins and the surface of the coin track on which the coins slide may be larger than zero.

A determination threshold by which the recognition unit determines the authenticity of the coins may be changeable.

A determination threshold by which the recognition unit determines the fitness of the coins may be changeable.

The coin handling apparatus may further have a second opening provided in a surface of the coin track on which the coins slide and configured to receive foreign matters.

This configuration allows for removing foreign matters that follow the coins traveling along the coin track from the coin track through the second opening.

### BRIEF DESCRIPTION OF THE DRAWINGS

FIG. 1 is a perspective view illustrating an appearance of a coin handling apparatus.

FIG. 2 is a perspective view illustrating an internal configuration for the coin handling apparatus.

FIG. 3 is a plan view illustrating a sorting unit.

FIG. 4 is a cross-sectional view taken along the plane IV-IV in FIG. 3.

FIG. 5 is a perspective view illustrating a coin moving disk.

FIG. 6 is a block diagram illustrating a configuration for the coin handling apparatus.

FIG. 7 illustrates a plan view of a collection receptacle at the top, and a cross-sectional view of the collection receptacle at the bottom.

FIG. 8 is a transition diagram illustrating coins accumulating in the collection receptacle.

FIG. 9 is a timing chart illustrating encoder pulses used for coin tracking control and detection signals of respective sensors.

FIG. 10 illustrates an on-screen image which is displayed on a display of the coin handling apparatus.

### DETAILED DESCRIPTION

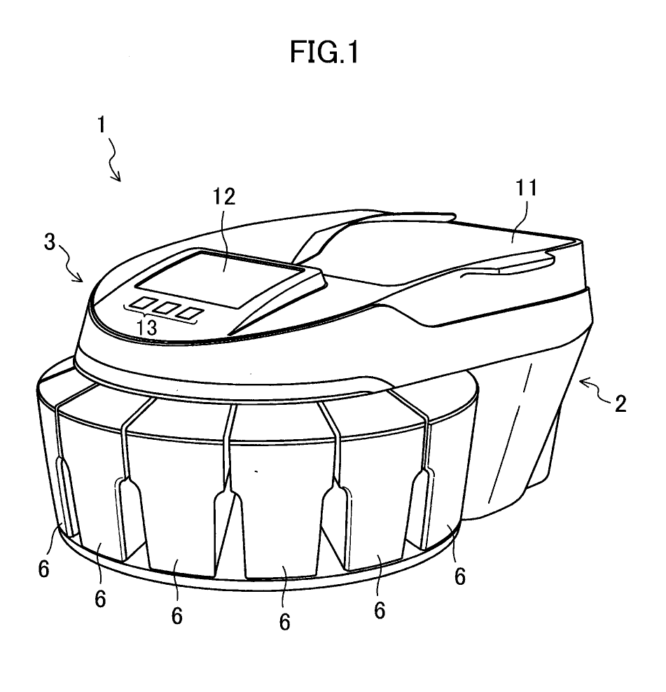

A coin handling apparatus disclosed herein will be described in detail with reference to the drawings. Note that the following description is merely an example. FIG. 1 shows the appearance of a coin handling apparatus 1. This coin handling apparatus 1 is a desktop type.

In the following description, for the sake of convenience, a front left side of the apparatus illustrated on the paper of FIG. 1 will be referred to herein as a “front side” of the coin handling apparatus, and a rear right side of the apparatus illustrated on the paper will be referred to herein as a “rear side” of the coin handling apparatus.

### (General Configuration for Coin Handling Apparatus)

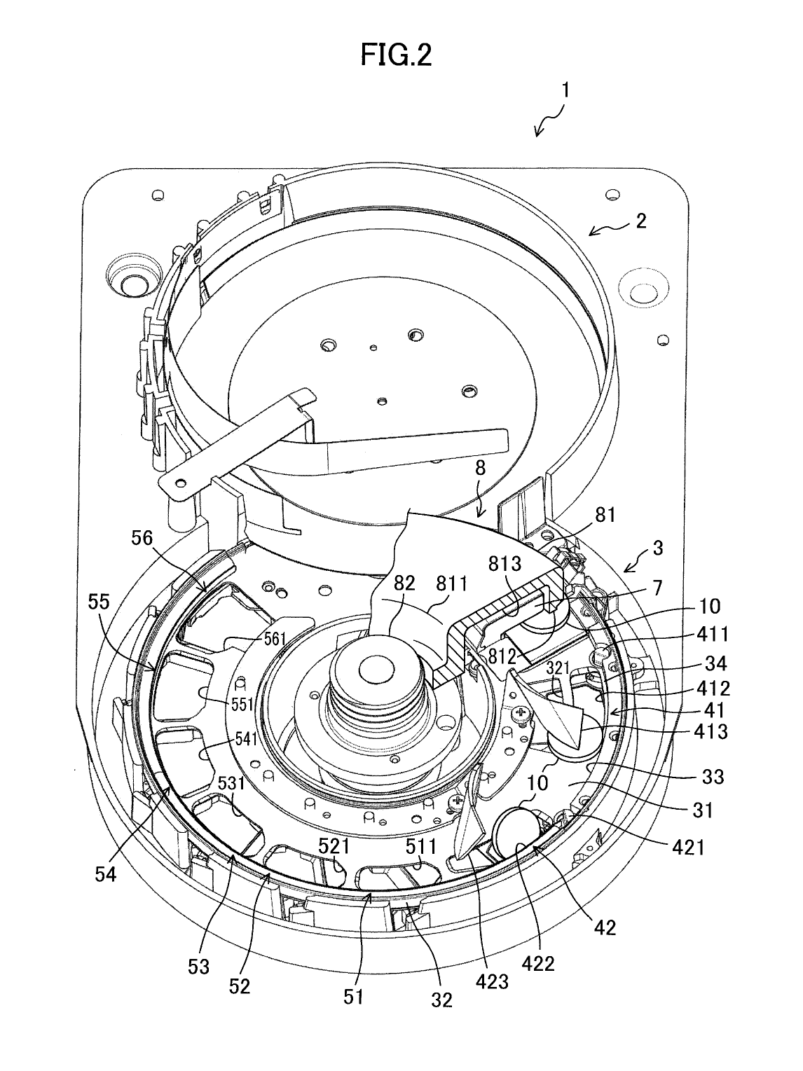

FIG. 2 illustrates an internal configuration for the coin handling apparatus 1. The coin handling apparatus 1 includes a feeding unit 2 disposed on the rear side thereof and a handling unit 3 disposed on the front side thereof. Inside the coin handling apparatus 1, the feeding and handling units 2 and 3 that are integrated together generally have an “8” shape when viewed from above.

As illustrated in FIG. 1, the coin handling apparatus 1 includes an inlet 11 in which coins are dropped. The inlet 11 is opened upward in a rear portion of the upper surface of the coin handling apparatus 1. The inlet 11 is connected to the feeding unit 2. The coins dropped into the inlet 11 enter the feeding unit 2. The feeding unit 2 is configured to feed the coins one by one to the handling unit 3.

A display 12 and an operating unit 13 are provided on a front portion of the upper surface of the coin handling apparatus 1.

The coin handling apparatus 1 further includes a plurality of collection receptacles 6. These collection receptacles 6 are arranged side by side along a front arcuate portion of the coin handling apparatus 1. Each of the collection receptacles 6 is attachable and detachable to/from the coin handling apparatus 1. As will be described later, each of the collection receptacles 6 is connected to first or second active sorting unit 41 or 42, or an associated one of first to sixth passive sorting units 51-56 of the handling unit 3.

The handling unit 3 sorts the coins according to their denominations. The exemplary coin handling apparatus 1 illustrated on the drawings is able to sort out United States 1 cent coins (pennies), 5 cent coins (nickels), 10 cent coins (dimes), 25 cent coins (quarters), 50 cent coins, and 1 dollar coins from each other. Further, the handling unit 3 is able to sort out forged coins and unfit coins (i.e., offsort these coins). Note that the coin handling apparatus 1 is not used only for sorting the US coins, but may also be used for sorting coins of other countries.

The handling unit 3 includes a coin track 31, a recognition unit 7, first and second active sorting units 41 and 42, first to sixth passive sorting units 51-56, and a driving unit 8.

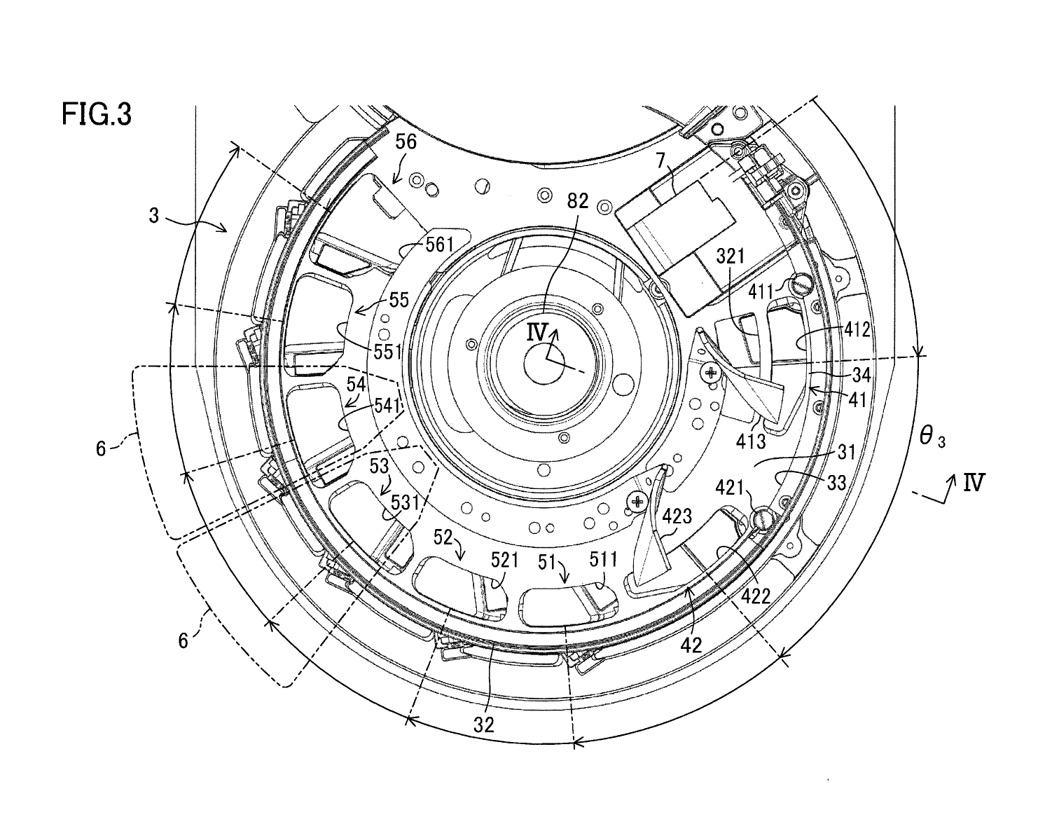

FIG. 3 shows the handling unit 3 as viewed from above. The handling unit 3 includes a base member 32. The coin track 31 is provided on an upper surface of the base member 32. The coin track 31 is a passage through which the coins travel. The coin track 31 is an arcuate track extending along an outer peripheral edge of the base member 32 having a substantially disklike shape. The coin track 31 has a width larger than the maximum one of the diameters of coins 10 to be handled by the coin handling apparatus 1. An upstream end of the coin track 31 is an upper right portion thereof on the paper on which FIG. 3 is drawn. At the upstream end, the coin track 31 receives the coins 10 from the feeding unit 2. The coins 10 travel in the clockwise direction in FIG. 3 along the coin track 31. A downstream end of the coin track 31 is an upper left portion thereof on the paper on which FIG. 3 is drawn.

The coin track 31 has an arcuate reference edge 33 at an outer peripheral edge of the base member 32. The arcuate reference edge 33 is curved along the coin track 31. The arcuate reference edge 33 regulates an outer peripheral edge of the coin 10 traveling along the coin track 31.

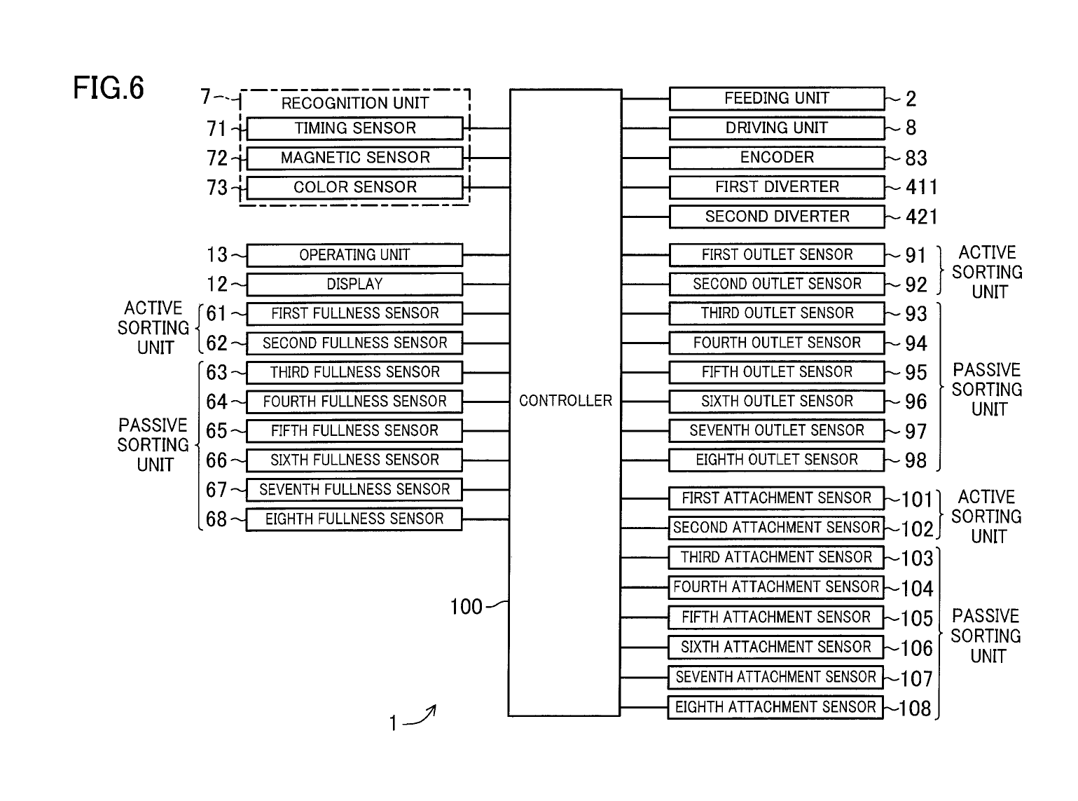

The recognition unit 7 recognizes each of the coins 10 passing through the recognition unit 7. The recognition unit 7 is disposed upstream of the coin track 31. The recognition unit 7 includes, as shown in FIG. 6, a timing sensor 71, a magnetic sensor 72, and a color sensor 73. Although not illustrated in detail, the magnetic and color sensors 72 and 73 are located downstream of the timing sensor 71. The timing sensor 71 senses the passage of the coins 10. The magnetic and color sensors 72 and 73 start sensing in response to the timing sensor's (71) sensing of the passage of the coin 10. The magnetic sensor 72 senses magnetic information of each coin 10. The color sensor 73 senses information about the color of the surface of each coin 10. Based on the sensing results obtained by these sensors 72 and 73, the recognition unit 7 determines at least the denomination, authenticity, or fitness of each coin 10.

The first and second active sorting units 41 and 42 actively sort the coins 10 based on the recognition results. The first and second active sorting units 41 and 42 are disposed along the coin track 31. The first active sorting unit 41 is disposed downstream of the recognition unit 7. The second active sorting unit 42 is disposed downstream of the first active sorting unit 41. Coins 10 that are not received by the first and second active sorting units 41 and 42 (e.g., genuine and fit coins) pass through the first and second active sorting units 41 and 42.

The first and second active sorting units have substantially the same configuration. Now, the configuration of the first active sorting unit 41 will be described below with description of the configuration of the second active sorting unit 42 omitted.

The first active sorting unit 41 has a first diverter 411. The first diverter 411 operates to move selectively the coins 10 traveling along the coin track 31 away from the arcuate reference edge 33. The first diverter 411 includes a shaft having a semicircular cross section. The shaft is disposed along the arcuate reference edge 33. The shaft is rotatable. When rotates, the semicircular shaft projects into the coin track 31 as shown in FIG. 3. The coins 10 traveling along the coin track 31 collide against the shaft to move in a direction away from the arcuate reference edge 33. The first diverter 411 rotates the shaft in response to a drive signal from a controller 100 to be described later.

The first active sorting unit 41 includes a first sorting opening 412. The first sorting opening 412 is cut through the base member 32. The first sorting opening 412 penetrates the base member 32. The first sorting opening 412 is disposed downstream of the first diverter 411. The first sorting opening 412 receives the coins 10 which have been moved by the first diverter 411 in the direction away from the arcuate reference edge 33.

In the base member 32, a narrow rail portion 34 is provided between the first sorting opening 412 and the arcuate reference edge 33. The first sorting opening 412 is disposed at an interval from the arcuate reference edge 33 in a radially inward direction. The rail portion 34 extends along the arcuate reference edge 33 from the upstream to downstream ends of the coin track 31. The first sorting opening 412 has a radial width smaller than the minimum one of the diameters of the coins 10 to be handled by the coin handling apparatus 1. The first sorting opening 412 may have a predetermined width in the circumferential direction. The coin 10 that is going to pass through the first active sorting unit 41 passes over the first sorting opening 412 with its edge traveling over the rail portion 34 as shown in FIG. 2. The coin 10 that is going to be received by the first active sorting unit 41 is moved by the first diverter 411 in the direction away from the arcuate reference edge 33. Thus, the edge of the coin leaves the rail portion 34 to overhang the first sorting opening 412. Then, the coin 10 inclines over the first sorting opening 412 to fall into the first sorting opening 412. The collection receptacles 6 are attached under the base member 32. The coin that has fallen into the first sorting opening 412 is accumulated in one of the collection receptacles 6. Note that the example shown in FIG. 2 illustrates how the coin 10 that has inclined falls into a second sorting opening 422 to be described later.

The first sorting opening 412 has upper and lower opening edges on the upper and lower surfaces of the base member 32, respectively, which are located at different positions and have different shapes. The upper opening edge of the first sorting opening 412 is positioned and shaped appropriately to receive the coins 10 from the coin track 31 easily. The lower opening edge of the first sorting opening 412 has a position and a shape corresponding to those of an associated one of the collection receptacles 6.

The first active sorting unit 41 includes a first deflector 413. The first deflector 413 is disposed downstream of the first sorting opening 412. The first deflector 413 is disposed over the first sorting opening 412 to leave an interval that allows the coins 10 to pass through, and is positioned so as to contact with a tipped up edge of each of the coins 10. The coins 10 passing through the first active sorting unit 41 travel under the first deflector 413. The coins 10 to be received by the first active sorting unit 41 hit the first deflector 413 by their tipped up edges, and are deflected into the first sorting opening 412. Irrespective of their size, the coins 10 fall into the first sorting opening 412 with reliability.

The second active sorting unit 42 has, as shown in FIG. 3, a second diverter 421, a second sorting opening 422, and a second deflector 423. An upper opening edge of the second sorting opening 422 on the upper surface of the base member 32 is positioned and shaped appropriately to receive the coins 10 from the coin track 31 easily. A lower opening edge of the second sorting opening 422 has a position and a shape corresponding to those of an associated one of the collection receptacles 6. The upper and lower opening edges of the second sorting opening 422 on the upper and lower surfaces of the base member 32 are located at different positions and have different shapes. The first and second sorting openings 412 and 422 have the same shape.

The interval between the first sorting opening 412 of the first active sorting unit 41 and the second sorting opening 422 of the second active sorting unit 42 is larger than the interval between adjacent ones of sorting openings 511, 521, 531, 541, 551, and 561 of passive sorting units 51-56 to be described later.

The first and second active sorting units 41 and 42 sort the coins 10 by driving the first and second diverters 411 and 421. Thus, these active sorting units 41 and 42 may be called “driving sorting units.”

The first to sixth passive sorting units 51-56 passively sort the coins 10 according to the difference in diameter between the coins 10. The first to sixth passive sorting units 51-56 are arranged along the coin track 31. The first to sixth passive sorting units 51-56 are disposed downstream of the second active sorting unit 42. The first to sixth passive sorting units 51-56 are arranged in this order from an upstream point to a downstream point of the coin track 31. The sixth passive sorting unit 56 corresponds to the downstream end of the coin track 31.

The passive sorting units 51-56 have sorting openings 511, 521, 531, 541, 551, and 561, respectively. The sorting openings 511, 521, 531, 541, 551, and 561 are cut through the base member 32. The sorting openings 511, 521, 531, 541, 551, and 561 penetrate the base member 32. The rail portion 34 is provided between the sorting openings 511, 521, 531, 541, 551, and 561 and the arcuate reference edge 33. Just like the first and second sorting openings 412 and 422 of the first and second active sorting units 41 and 42, each of the sorting openings 511, 521, 531, 541, 551, and 561 of the passive sorting units 51-56 also has upper and lower opening edges on the upper and lower surfaces of the base member 32, which are located at different positions and have different shapes. The upper opening edge of each of the sorting openings 511, 521, 531, 541, 551, and 561 is positioned and shaped appropriately to receive the coins 10 from the coin track 31 easily. The lower opening edge of each of the sorting openings 511, 521, 531, 541, 551, and 561 has a position and a shape corresponding to those of an associated one of the collection receptacles 6.

The sorting openings 511, 521, 531, 541, 551, and 561 of the first to sixth passive sorting units 51-56 have mutually different radial widths. The sorting opening 511 of the first passive sorting unit 51 has the narrowest radial width, while the sorting opening 561 of the sixth passive sorting unit 56 has the widest radial width. The radial width of the sorting openings 511, 521, 531, 541, 551, and 561 gradually increases in the ascending order of the ordinals of their passive sorting units, i.e., from the first passive sorting unit 51 to the sixth passive sorting unit 56. Each of the sorting openings 511, 521, 531, 541, 551, and 561 is configured to receive coins of diameters smaller than a predetermined size.

The width of the sorting opening 511 of the first passive sorting unit 51 corresponds to the minimum one of the diameters of the coins 10 to be handled by the coin handling apparatus 1. In the exemplary coin handling apparatus 1 illustrated on the drawings, the width of the sorting opening 511 of the first passive sorting unit 51 corresponds to the diameter of 10 cent coins. The first passive sorting unit 51 receives 10 cent coins. Coins 10 larger in diameter than 10 cent coins pass on through the first passive sorting unit 51.

The width of the sorting opening 521 of the second passive sorting unit 52 corresponds to the diameter of 1 cent coins, and thus the second passive sorting unit 52 receives 1 cent coins. Coins 10 larger in diameter than 1 cent coins pass on through the second passive sorting unit 52.

The width of the sorting opening 531 of the third passive sorting unit 53 corresponds to the diameter of 5 cent coins, and thus the third passive sorting unit 53 receives 5 cent coins. Coins 10 larger in diameter than 5 cent coins pass on through the third passive sorting unit 53.

The width of the sorting opening 541 of the fourth passive sorting unit 54 corresponds to the diameter of 25 cent coins, and thus the fourth passive sorting unit 54 receives 25 cent coins. Coins 10 larger in diameter than 25 cent coins pass on through the fourth passive sorting unit 54.

The width of the sorting opening 551 of the fifth passive sorting unit 55 corresponds to the diameter of 1 dollar coins, and thus the fifth passive sorting unit 55 receives 1 dollar coins. Coins 10 larger in diameter than 1 dollar coins pass on through the fifth passive sorting unit 55.

The width of the widest sorting opening 561 of the sixth passive sorting unit 56 corresponds to the diameter of 50 cent coins. The sixth passive sorting unit 56 receives 50 cent coins, and is able to receive all the coins that have reached the sixth passive sorting unit 56.

The sorting openings 511, 521, 531, 541, 551, and 561 of the passive sorting units 51-56 have substantially the same width in the circumferential direction. The circumferential width of the sorting openings 511, 521, 531, 541, 551, and 561 of the passive sorting units 51-56 is smaller than the circumferential width of the first and second sorting opening 412 and 422 of the first and second active sorting units 41 and 42.

As their portions are illustrated in phantom in FIG. 3, the collection receptacles 6 are attached respectively to the first to sixth passive sorting units 51-56 under the base member 32. The coins that have fallen through each of the sorting openings 511, 521, 531, 541, 551, and 561 are accumulated in an associated one of the collection receptacles 6.

The first to sixth passive sorting units 51-56 do not include any driving member such as the first and second diverters 411 and 421 of the first and second active sorting units 41 and 42. Thus, the first to sixth passive sorting units 51-56 may be called “non-driving sorting units.”

The base member 32 is provided with an opening 321 configured to remove foreign matters. The opening 321 is located radially inside the first sorting opening 412 of the first active sorting unit 41. The opening 321 penetrates the base member 32. Foreign matters that follow the coins 10 traveling along the coin track 31 are removed from the coin track 31 through the opening 321.

The driving unit 8 includes a motor (not shown) and a coin moving disk 81. The coin moving disk 81 moves the coins along the coin track 31. As only partially illustrated in FIG. 2, the coin moving disk 81 is disposed over the base member 32 to cover the coin track 31. The coin moving disk 81 is attached to a shaft 82 disposed at the center of the handling unit 3 and driven by the motor, and rotates in the clockwise direction in FIG. 2.

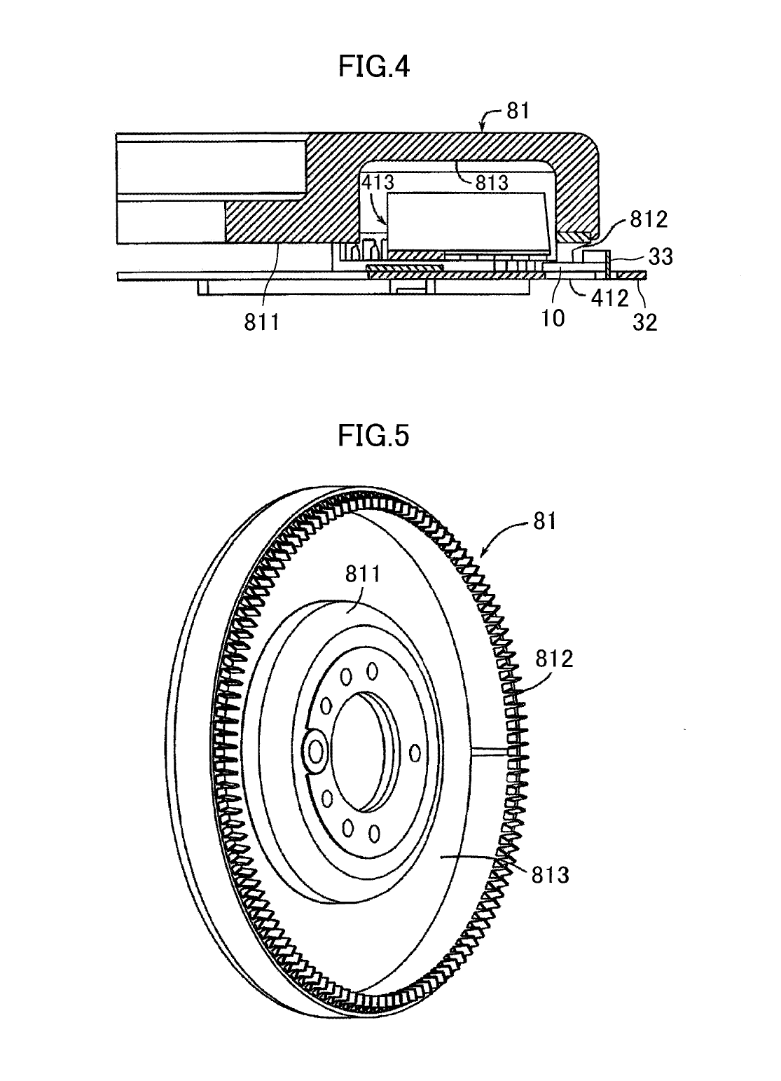

The coin moving disk 81 includes, as shown in FIGS. 4 and 5, a hub 811 attached to the motor-driven shaft 82, multiple fins 812 provided along an outer peripheral edge of the coin moving disk 81, and a recess 813 between the hub 811 and the fins 812.

The multiple fins 812 are provided on the lower surface of the coin moving disk 81. A large number of fins 812 extend downward and are arranged in the circumferential direction along the outer peripheral edge of the coin moving disk 81. The fins 812 are elastic members made of polyurethane, for example. A distance between the bottom of the fins 812 and a surface of the coin track 31 on which the coin slides is smaller than the thickness of the coin 10 and is larger than zero. The fins 812 contact with the upper surface of the coin 10 to press the coin 10 downward.

As shown in FIG. 2, the recess 813 of the coin moving disk 81 is provided to face the recognition unit 7 and the first and second deflectors 413 and 423 of the first and second active sorting units 41 and 42. The coin moving disk 81 rotates without interfering with any of the recognition unit 7 and the first and second deflectors 413 and 423.

The coin moving disk 81 rotates while pressing the coins 10 downward with the fins 812, thereby moving the coins 10 along the coin track 31.

In the first or second active sorting unit 41 or 42, the coin moved by the first or second diverter 411 or 421 in the direction away from the arcuate reference edge 33 is pressed by the coin moving disk 81. Thus, the coin inclines with reliability in the first or second sorting opening 412 or 422, and then falls into the first or second sorting opening 412 or 422 with reliability.

Likewise, in each of the first to sixth passive sorting units 51-56, if the sum of the radial width of the sorting opening 511, 521, 531, 541, 551, or 561 and the width of the rail portion 34 between the arcuate reference edge 33 and the sorting opening is larger than the diameter of a coin 10, the coin 10 pressed by the coin moving disk 81 falls into the sorting opening 511, 521, 531, 541, 551, or 561 with reliability.

FIG. 6 is a block diagram illustrating a configuration for the coin handling apparatus 1. The coin handling apparatus 1 includes a controller 100. The controller 100 is coupled to the feeding unit 2, the recognition unit 7, the driving unit 8 and the first and second diverters 411 and 421 of the first and second active sorting units 41 and 42 so that the controller 100 is able to transmit and receive signals to and from these units and diverters.

The controller 100 is also coupled to the display 12 and the operating unit 13. The display 12 displays various types of information. The display 12 may be configured as a touch panel display. The touch panel display 12 allows the user to perform various kinds of operations on an on-screen image on the display. The operating unit 13 functions as an interface between the user and this coin handling apparatus 1.

The first and second active sorting units 41 and 42 and the first to sixth passive sorting units 51-56 are provided with outlet sensors 91-98, respectively. The first and second outlet sensors 91 and 92 are provided for the first and second active sorting units 41 and 42, respectively. The third to eighth outlet sensors 93-98 are provided for the first to sixth passive sorting units 51-56, respectively. The first to eighth outlet sensors 91-98 are coupled to the controller 100 so that they are able to transmit and receive signals to and from the controller 100.

Each of the outlet sensors 91-98 senses that the coin 10 has passed the corresponding opening. That is, the outlet sensors 91-98 sense that the first and second active sorting units 41 and 42 and the first to sixth passive sorting units 51-56 have received the coin 10.

In this example, the first and second active sorting units 41 and 42 are supposed to be provided with the outlet sensors 91 and 92, respectively. However, the outlet sensors 91 and 92 may be omitted.

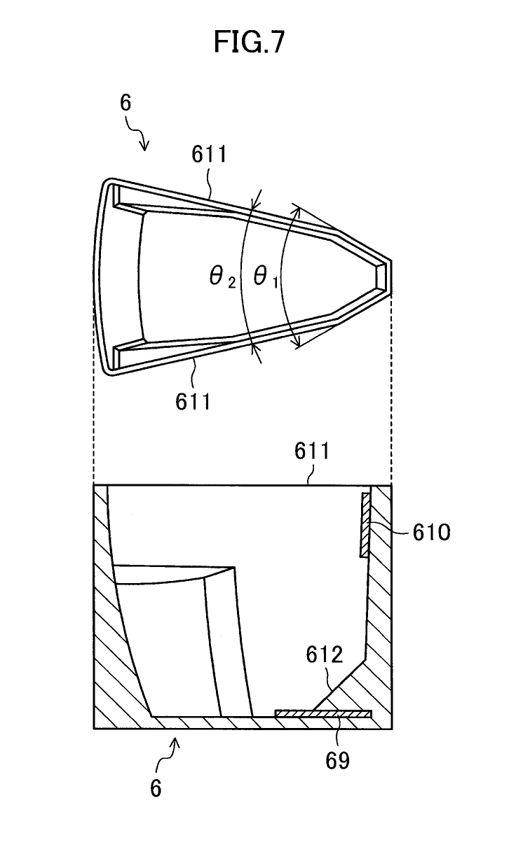

The first and second active sorting units 41 and 42 and the first to sixth passive sorting units 51-56 are provided with fullness sensors 61-68, each of which senses that an associated one of the collection receptacles 6 is full of coins. As shown in FIG. 7, each of the fullness sensors 61-68 includes sensing plates 69 and 610 attached respectively to the bottom and top of its associated collection receptacle 6. When the collection receptacle 6 is full of a large number of coins, the two sensing plates 69 and 610 become electrically conductive with each other through those coins. Each of the fullness sensors 61-68 senses that an associated one of the collection receptacles 6 is full of the coins by detecting the electrical conductivity between the two sensing plates 69 and 610. The first and second fullness sensors 61 and 62 are provided for the first and second active sorting units 41 and 42, respectively. The third to eighth fullness sensors 63-68 are provided for the first to sixth passive sorting units 51-56, respectively.

Each of the first to eighth fullness sensors 61-68 may be configured to sense that the associated one of the collection receptacles 6 is full. Alternatively, the first to eighth fullness sensors 61-68 may also be configured to sense that all of the collection receptacles 6 are full when any one of the receptacles 6 is full.

Still alternatively, instead of providing the first to eighth fullness sensors 61-68, the controller 100 may be configured to count, by software, the number of coins accumulated in each of the collection receptacles 6 so that the controller 100 is able to sense, with such a software counter, that the collection receptacle is full.

Moreover, attachment sensors 101-108 are also provided, each of which senses whether the collection receptacle 6 is attached or not to an associated one of the first and second active sorting units 41 and 42 and the first to sixth passive sorting units 51-56. The first to eighth fullness sensors 61-68 and the first to eighth attachment sensors 101-108 are coupled to the controller 100 so that these sensors are able to transmit and receive signals to and from the controller 100.

The driving unit 8 includes an encoder 83 which outputs a pulse signal according to a rotation angle of the motor. The encoder 83 outputs an encoder pulse to the controller 100.

The controller 100 receives signals from the operating unit 13, the recognition unit 7, the encoder 83, the outlet sensors 91-98, the fullness sensors 61-68, and the attachment sensors 101-108, and drives the feeding unit 2, the driving unit 8, and the first and second diverters 411 and 421, thereby operating the coin handling apparatus 1. In addition, the controller 100 displays various kinds of information on the display 12.

### (Operation Mechanism of Coin Handling Apparatus)

An operation mechanism of the coin handling apparatus 1 will be briefly described below.

First, before starting to use the coin handling apparatus 1, the types of coins to be sorted out into the first and second active sorting units 41 and 42 are determined. As described above, the first and second active sorting units 41 and 42 actively sort the coins 10 based on the recognition results. Each of the first and second active sorting units 41 and 42 may receive an arbitrary type of coins 10.

Alternatively, the first and second active sorting units 41 and 42 may be configured to sort the coins 10 according to their authenticity. For example, the first or second active sorting unit 41 or 42 may receive forged coins. Note that a determination threshold by which the recognition unit 7 determines the authenticity of the coins may be changeable. The determination threshold may be changed by a maintenance person of the coin handling apparatus 1.

Still alternatively, the first and second active sorting units 41 and 42 may sort the coins 10 according to their fitness. For example, the first or second active sorting unit 41 or 42 may receive unfit coins. Note that a determination threshold by which the recognition unit 7 determines the fitness of the coins may be changeable. The determination threshold may be changed by a maintenance person of the coin handling apparatus 1.

Yet alternatively, the first and second active sorting units 41 and 42 may sort the coins 10 according to whether the coins 10 are new or old. For example, the first or second active sorting unit 41 or 42 may receive new coins or may receive old coins.

Yet alternatively, the first and second active sorting units 41 and 42 may sort the coins 10 according to their diameters. That is, the first or second active sorting unit 41 or 42 may be used just like the passive sorting units 51-56. Optionally, the first or second active sorting unit 41 or 42 may receive the coins 10 of a particular type having the same diameter as the coins 10 to be received by the passive sorting units 51-56.

Yet alternatively, the first and second active sorting units 41 and 42 may sort the coins according to their denominations. According to this configuration, the first or second active sorting unit 41 or 42 may also be used just like the passive sorting units 51-56. In this case, each of the first and second active sorting units 41 and 42 may receive a predetermined number of coins 10 of a selected denomination. That is, use of the first or second active sorting unit 41 or 42 allows for performing a batch process. Since the coin handling apparatus 1 has the two active sorting units 41 and 42, one of the first and second active sorting units 41 and 42 may be set to receive forged coins and unfit coins, while the other may be set to perform a batch process.

Yet alternatively, the first and second active sorting units 41 and 42 may sort the coins 10 according to a predetermined rejection factor. For example, the first or second active sorting unit 41 or 42 may receive suspected coins.

Yet alternatively, the first and second active sorting units 41 and 42 may sort the coins 10 according to a predetermined overflow factor. For example, if a collection receptacle 6 to receive coins of a certain denomination is full of the coins while providing reserve funds of multiple different denominations (i.e., when a batch process is performed to count user-specified numbers of coins of user-specified denominations), the first or second active sorting unit 41 or 42 may receive the coins of the denomination so as to allow the coin handling apparatus 1 to continue the handling. If any abnormality, e.g., a chain of coins 10 are moving together, is detected, the first or second active sorting unit 41 or 42 may receive such coins 10 so as to continue the handling without stopping the coin handling apparatus 1. Further, one of the first and second active sorting units 41 and 42 may be configured to receive coins of a type that is not allocated to the other sorting units, namely, the first to sixth passive sorting units 51-56 and the other one of the first and second active sorting units 41 and 42.

Still alternatively, the first and second active sorting units 41 and 42 may be configured to receive coins that are not received by the first to sixth passive sorting units 51-56.

In the following description, an exemplary operation mechanism of the coin handling apparatus 1 will be described on the supposition that forged coins and suspected coins are sorted out by the first active sorting unit 41, and unfit coins are sorted out by the second active sorting unit 42.

When a user drops the coins 10 into the inlet 11 and operates the operating unit 13, the coin handling apparatus 1 starts the handling of the coins. The feeding unit 2 feeds the coins 10 one by one to the handling unit 3. The coins 10 are moved by the coin moving disk 81 along the coin track 31 in a single layer and a single file.

The recognition unit 7 recognizes each of the coins 10. The controller 100 rotates the first diverter 411 such that the forged coins and the suspected coins are sorted out by the first active sorting unit 41 based on the recognition results. That is, the shaft is rotated when each of the coins 10 selected based on the recognition results reaches the first diverter 411. The coins 10 are moved in a direction away from the arcuate reference edge 33, and thus fall into the first sorting opening 412 of the first active sorting unit 41. The coins 10 are then housed in the collection receptacle 6 attached to the first active sorting unit 41.

Further, the controller 100 rotates the second diverter 421 such that the unfit coins are sorted out by the second active sorting unit 42 based on the recognition results. That is, the shaft is rotated when each of the coins 10 selected based on the recognition results reaches the second diverter 421. The coins 10 are moved in the direction away from the arcuate reference edge 33, and thus fall into the second sorting opening 422 of the second active sorting unit 42. The coins 10 are then housed in the collection receptacle 6 attached to the second active sorting unit 42.

Genuine and fit coins pass on through the first and second active sorting units 41 and 42. Each of the coins 10 falls into, according to its diameter size, any one of the sorting openings 511, 521, 531, 541, 551, and 561 of the first to sixth passive sorting units 51-56, and is housed in the collection receptacle 6 attached to the one of the passive sorting units 51-56.

When all the coins 10 dropped into the inlet 11 are housed in any combination of the collection receptacles 6, the coin handling apparatus 1 stops. Then, the controller 100 presents, on the display 12, the total amount of the coins handled, for example. Alternatively, the controller 100 may also present, on the display 12, the counts of the coins of different denominations on a denomination-by-denomination basis, for example.

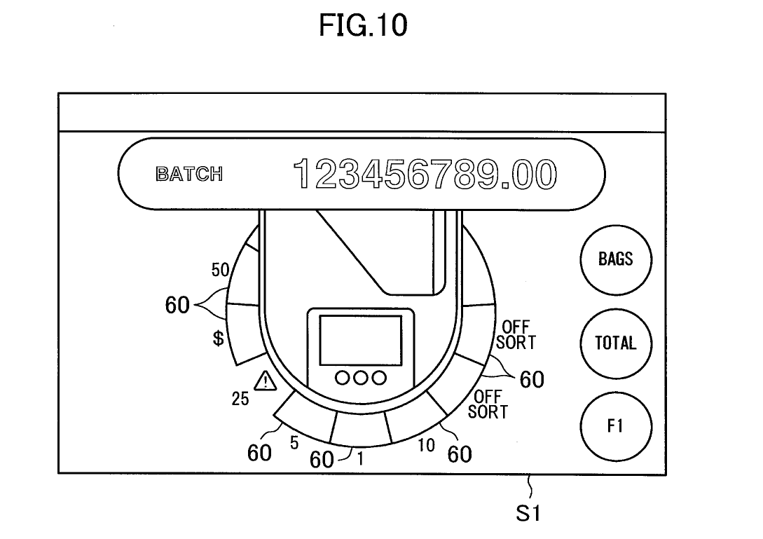

An exemplary on-screen image S1 to be displayed on the display 12 of the coin handling apparatus 1 will be described with reference to FIG. 10. The on-screen image S1 includes an illustration of the coin handling apparatus 1 as viewed from above. The on-screen image S1 includes illustrations 60 representing the collection receptacles attached to the first and second active sorting units 41 and 42 and the first to sixth passive sorting units 51-56. These illustrations 60 are arranged in the same order as the actual collection receptacles 6. Each of the illustrations 60 of the collection receptacles on the on-screen image S1 is also displayed along with the denomination of the coins housed in the collection receptacle 6. Since no collection receptacle 6 is attached to the fourth passive sorting unit 54 supposed to receive 25 cent coins as will be described later, no illustration 60 representing this collection receptacle 6 is shown in FIG. 10.

The controller 100 changes the colors of the illustrations 60 of the collection receptacles 6 on the on-screen image S1 according to the status of the collection receptacles 6, or changes the illustrations 60 themselves. Specifically, the controller 100 displays the illustrations 60 of the collection receptacles which either are still empty or already house the coins 10 in blue. When the controller 100 recognizes that one of the collection receptacles 6 is almost full based on the count of the software counter, the controller 100 changes the colors of the illustration 60 of that collection receptacle 6 into yellow. When the software counter or any one of the fullness sensors 61-68 senses that one of the collection receptacles 6 is full of the coins, the controller 100 changes the colors of the illustration 60 of that collection receptacle into red. The controller 100 may display the illustration 60 of the collection receptacle housing no coins 10 in the background color of the on-screen image S1, for example (i.e., in a colorless state), instead of blue, yellow or red. Further, if one of the attachment sensors 101-108 senses that no collection receptacle 6 is attached, the controller 100 may highlight its absence on the on-screen image S1 as illustrated in FIG. 10. Alternatively, the illustrations 60 of the collection receptacles may also be displayed so as to blink.

Display of such an on-screen image S1 on the display 12 allows the user to understand at a glance the status of each of the collection receptacles 6. This may prevent the user from operating this apparatus erroneously.

As can be seen from the foregoing, the coin handling apparatus 1 includes a plurality of active sorting units 41 and 42 which actively sort the coins 10 based on the recognition results obtained by the recognition unit 7. This configuration allows for performing the sorting of the coins according to their authenticity and the sorting of the coins according to their fitness in a single handling process. The coin handling apparatus 1 is able to feed arbitrary types of coins 10 selectively to a plurality of sorting units. This coin handling apparatus 1 is applicable to various types of handling.

### (Configuration for Collection Receptacle)

FIG. 7 shows one of the collection receptacles 6. The collection receptacles 6 are arranged along the arcuate portion of the apparatus as described above. Each of the collection receptacles 6 is in the shape of a fan when viewed from above. A proximal end portion of the receptacle (i.e., a right end portion in FIG. 7) has a narrower interval between two vertical walls 611, 611, and a distal end portion of the receptacle (i.e., a left end portion in FIG. 7) has a wider interval between the two vertical walls 611, 611. An opening of the collection receptacle 6 communicates with the first or second sorting opening 41 or 42, or one of the first to sixth sorting openings 511, 521, 531, 541, 551, and 561. Since the interval between the two vertical walls 611, 611 is narrow in the proximal end portion of the collection receptacle 6, a coin 10 with a large diameter may be caught in the interval between the vertical walls 611, 611. The coin 10, if caught in the interval between the vertical walls, may possibly remain in the collection receptacle 6 when the collection receptacle 6 is removed from the coin handling apparatus 1 to collect the coins 10 therein.

Thus, to overcome this problem, the collection receptacle 6 is configured such that the vertical walls 611, 611 of the proximal end portion form an angle θ₁ larger than an angle θ₂ formed by the vertical walls 611, 611 of the other portion. Each of the vertical walls 611, 611 of the collection receptacle 6 is bent at a portion between the proximal and distal end portions. In the proximal end portion of the collection receptacle 6, the two vertical walls 611, 611 form a larger angle between them, and thus the coin 10 may be prevented from being caught in the interval between the vertical walls.

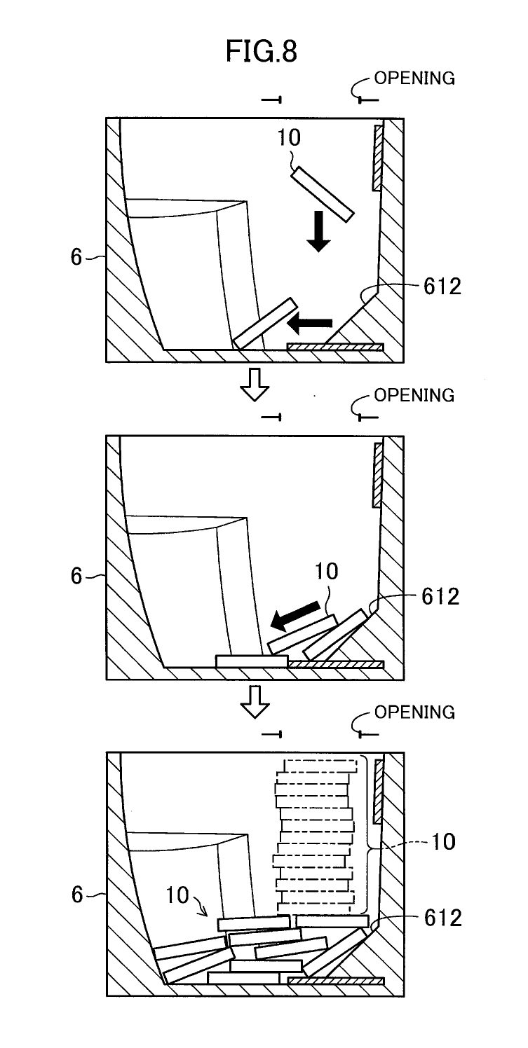

The bottom of the proximal end portion of the collection receptacle 6 has a slope 612 as shown in the bottom drawing of FIG. 7. The slope 612 is located below the first or second sorting opening 41 or 42, or one of the first to sixth sorting openings 511, 521, 531, 541, 551, and 561. As shown in FIG. 8, the coin 10 that falls into the receptacle through the sorting opening travels along the slope 612 toward the distal end of the collection receptacle 6 as indicated by the solid arrows. Thus, the coins 10 are housed evenly in the distal and proximal end portions of the collection receptacle 6. For example, as illustrated in phantom in the bottom drawing of FIG. 8, the coins 10 may thus be prevented from being stacked one upon the other below the opening in the collection receptacle 6.

Note that the collection receptacle is illustrated to have a thick wall in FIGS. 7 and 8 for the sake of simplicity, but the collection receptacle may be configured to have a thin wall.

### (Coin Tracking Control)

The coin handling apparatus 1 is configured to track the coin 10 traveling along the coin track 31 using encoder pulses.

As can be seen from the foregoing, the encoder 83 outputs an encoder pulse corresponding to the rotation angle of the motor, that is, the rotation angle of the coin moving disk 81.

As shown in FIG. 3, the first and second active sorting units 41 and 42 and the first to sixth passive sorting units 51-56 are disposed along the arcuate coin track 31. The angles θ₃ formed between the timing sensor 71 of the recognition unit 7 and each of the first and second active sorting units 41 and 42 and the first to sixth passive sorting units 51-56 are different from each other. Thus, the number of encoder pulses C₁ generated from a point in time when the timing sensor 71 senses the coin 10 to a point in time when the outlet sensor senses the fall of the moved coin 10 into the opening of the predetermined sorting unit varies on a sorting unit basis, i.e., depending on which of the first and second active sorting units 41, 42 and first to sixth passive units 51-56 the coin 10 is eventually sorted out by.

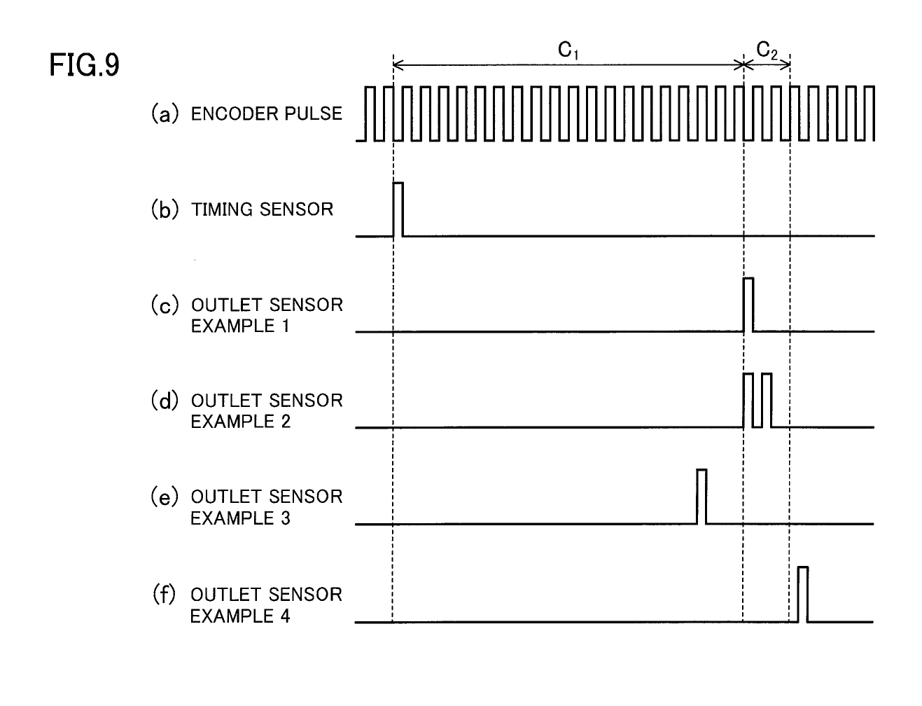

As shown in FIG. 9, the controller 100 tracks the coin 10 from a point in time when the coin 10 passed the timing sensor 71 to a point in time when the coin 10 falls into the opening of any one of the sorting units based on (a) the encoder pulses, (b) the detection signal of the timing sensor 71 of the recognition unit 7, and (c)-(f) the detection signals of the first to eighth outlet sensors 91-98.

Specifically, when the sorting unit to receive the coins 10 is set based on the recognition results of the recognition unit 7, the number of encoder pulses C₁ generated from a point in time when the timing sensor 71 sensed the passage of the coin 10 to a point in time when the outlet sensor senses the fall of the moved coin 10 into the opening of the predetermined sorting unit is determined.

The controller 100 starts to count the encoder pulses based on the detection signal of the timing sensor 71. Then, for example, the controller 100 determines that the coin 10 has been sorted out normally if the detection signal of the outlet sensor indicates correctly the number of the encoder pulses C₁ associated with the angle θ₃ of the sorting unit into which the coin 10 is supposed to fall as shown in Example 1 of portion (c) of FIG. 9. If the detection signal of the outlet sensor indicates a number falling within a predetermined count range C₂, the controller 100 may determine that the coin 10 has been sorted out normally.

Further, as described above, if the outlet sensors 91 and 92 of the first and second active sorting units 41 and 42 are omitted, the outlet sensors 93-98 of the first to sixth passive sorting units 51-56 located downstream of the active sorting units 41 and 42 may be monitored so as to allow the controller 100 to determine that the coins have been sorted out normally by the active sorting units 41 and 42 if the outlet sensors 93-98 do not make any difference within a predetermined time period.

On the other hand, as shown in Example 2 of portion (d) of FIG. 9, the controller 100 determines that some abnormality has occurred when a plurality of detection signals are output from the outlet sensor, even if the count of these detection signals of the outlet sensor is within the predetermined count range C₂ of the encoder pulses.

Further, when the detection signal of the outlet sensor is output ahead of the predetermined count range C₂ of the encoder pulses as shown in Example 3 of portion (e) of FIG. 9, for example, the controller 100 determines that some abnormality has occurred (e.g., the coin has fallen erroneously).

Moreover, when the detection signal of the outlet sensor is output behind the predetermined count range C₂ of the encoder pulses as shown in Example 4 of portion (f) of FIG. 9, the controller 100 determines that traveling of the coin 10 lags behind the rotation of the coin moving disk 81. When the controller 100 determines that such lag of the coin 10 occurs frequently, the controller 100 may determine that the fins 812 of the coin moving disk 81 have been worn, for example. In this state, the controller 100 may inform the user that the coin moving disk 81 needs to be replaced.

By tracking the coins 10 using the encoder pulses associated with the rotation angles of the coin moving disk 81, the coins 10 may be tracked based on the rotation angle of the coin moving disk 81. This is advantageous because the coins 10 are trackable correctly even if the rotation velocity of the coin moving disk 81 varies.

The above-described coin handling apparatus 1 includes the first and second active sorting units 41 and 42 and the first to sixth passive sorting units 51-56. However, the number of the active sorting units to provide and the number of the passive sorting units to provide do not have to be two and six, respectively, and may be changed as appropriate.

The configuration for the active sorting units is not limited to that described above. Various other configurations are conceivable to allow the active sorting units to receive arbitrary coins 10, and may be applicable to the active sorting units as appropriate.

1. A coin handling apparatus comprising:
a recognition unit configured to recognize coins;
an arcuate coin track configured to move the recognized coins;
a driving unit configured to move the coins along the coin track in a single layer and a single file;
a rotation angle detector configured to detect a rotation angle of the driving unit;
a plurality of active sorting units disposed in the coin track each configured to actively sort the coins based on different recognition results; and
a plurality of passive sorting units disposed in the coin track and configured to passively sort the coins based on the recognition results.

2. The coin handling apparatus of claim 1, wherein
the coin track has an arcuate reference edge disposed along the coin track and configured to regulate an outer peripheral edge of each coin traveling along the coin track, and
each of the active sorting units includes
a diverter disposed along the arcuate reference edge and configured to be operable to project into the coin track in order to move the coins selected based on the recognition results and the results of detection by the rotation angle detector in a direction away from the arcuate reference edge,
an opening spaced by a rail portion so as to be located at a predetermined interval from the arcuate reference edge and configured to receive the coins moved by the diverter in the direction away from the arcuate reference edge, and
a deflector disposed above the opening to leave a gap that allows the coins to pass through, positioned to contact with a tipped up edge of each of the coins, and configured to deflect the coins into the opening.

3. The coin handling apparatus of claim 2, wherein
the passive sorting unit is spaced by the rail portion so as to be located at a predetermined interval from the arcuate reference edge and has an opening configured to receive the coins having a smaller diameter than a predetermined size.

4. The coin handling apparatus of claim 1, wherein
the passive sorting unit is disposed downstream of the plurality of active sorting units in a traveling direction of the coins.

5. The coin handling apparatus of claim 1, wherein
the active sorting units sort the coins according to authenticity of the coins.

6. The coin handling apparatus of claim 1, wherein
the active sorting units sort the coins according to fitness of the coins.

7. The coin handling apparatus of claim 1, wherein
the active sorting units sort the coins according to whether the coins are new or old.

8. The coin handling apparatus of claim 1, wherein
the active sorting units sort the coins according to diameters of the coins.

9. The coin handling apparatus of claim 1, wherein
the active sorting units sort the coins according to denominations of the coins.

10. The coin handling apparatus of claim 9, wherein
the active sorting units receive only a predetermined number of coins of a selected denomination.

11. The coin handling apparatus of claim 1, wherein
the active sorting units sort the coins according to a predetermined rejection factor.

12. The coin handling apparatus of claim 1, wherein
the active sorting units sort the coins according to a predetermined overflow factor.

13. The coin handling apparatus of claim 1, wherein
the active sorting units receive coins that are not received by the passive sorting unit.

14. The coin handling apparatus of claim 1, wherein
the driving unit includes a plurality of elastic fins provided on a lower surface of a coin moving disk and configured to press each of the coins traveling along the coin track from above, the coin moving disk rotating about a shaft, and
a distance between a bottom of the elastic fins and a surface of the coin track on which the coins slide is smaller than a thickness of the coins.

15. The coin handling apparatus of claim 14, wherein
the distance between the bottom of the elastic fins and the surface of the coin track on which the coins slide is larger than zero.

16. The coin handling apparatus of claim 1, wherein
a determination threshold by which the recognition unit determines the authenticity of the coins is changeable.

17. The coin handling apparatus of claim 1, wherein
a determination threshold by which the recognition unit determines the fitness of the coins is changeable.

18. The coin handling apparatus of claim 1, further comprising:
a second opening provided in a surface of the coin track on which the coins slide and configured to remove foreign matters.

19. The coin handling apparatus of claim 1, wherein
the rotation angle detector is comprised of an encoder.
